(19) United States
(12) Patent Application Publication
(10) Pub. No.: US 2003/0036940 A1
(43) Pub. Date: Feb. 20, 2003

(54) Dynamic and adaptive definition of the evaluation sequence of transition conditions in workflow management systems

(75) Inventors: Frank Leymann, Aidlingen (DE); Dieter Roller, Schoenaich (DE)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY

(21) Appl. No.: 10/222,689

(22) Filed: Aug. 16, 2002

(30) Foreign Application Priority Data
Aug. 16, 2001 (EP) 01119831.4

(51) Int. Cl. G06F 17/60

(52) U.S. Cl. 705/8

(57) ABSTRACT

The present invention relates to a computerized method and system for improving the processing of transition conditions within a Workflow Management System (WFMS) or a computer system with comparable functionality. It is assumed that the WFMS controls the execution of a process-instance being the instance of a process model of a business process. Moreover, the process model comprises a multitude of transition conditions relating to a multitude of process activities respectively, which, if evaluated to TRUE, decide whether any of the corresponding activities is to be launched for execution. The method comprises a definition step dynamically and adaptively defining an evaluation sequence of said transition conditions. Moreover, the method comprises a launching step, wherein the activities corresponding to the transition conditions are launched for execution in the evaluation sequence, if the corresponding transition conditions evaluate to TRUE. The invention is applicable in situations wherein the transition conditions are associated with control connectors as well as in situations wherein the transition conditions are comprised by so-called decision nodes.

### BACKGROUND OF THE INVENTION

1. Field of the Invention

The current invention relates to means and a computerized method improving the processing of transition-conditions within a Workflow Management System or a computer system with comparable functionality (WFMS).

2. Description of the Related Art

A new area of technology with increasing importance is the domain of Workflow Management Systems (WFMS). WFMS support the modeling and execution of business processes. Business processes executed within a WFMS environment control who will perform which piece of work of a network of pieces of work and which resources are exploited for this work. The individual pieces of work might be distributed across a multitude of different computer systems connected by some type of network.

The product “IBM MQSeries Workflow” (previously called IBM FlowMark) represents such a typical modern, sophisticated, and powerful workflow management system. It supports the modeling of business processes as a network of activities. This network of activities, the process model, is constructed as a directed, acyclic, weighted, colored graph. The nodes of the graph represent the activities, which are performed. The edges of the graph, the control connectors, describe the potential sequence of execution of the activities. Definition of the process graph is via IBM MQSeries Workflow's Flow Definition Language (FDL) or via the built-in graphical editor. The runtime component of the Workflow Management System uses the process model as a template to create process instances.

Transition conditions are the means by which it is possible to specify in a further level of granularity the flow of control in a process model. Such transition conditions maybe realized as Boolean expressions which are evaluated by the WFMS at runtime to further determine if and which activity may be started. Parameters from output containers of activities having already produced their results are followed as parameters referenced in transition conditions. When at run time an activity terminates successfully all control connectors leaving this activity are determined and the truth value of the associated transition conditions is computed based on the actual values of their parameters. Only the end points of control connectors the transition conditions of which evaluated to TRUE are considered as activities that might be executed based on the actual context of the business process. Transition conditions model thus the context dependent actual flow of control within a business process (i.e., an instance of a model).

With the extended deployment of WFMS the complexity of the process models increased significantly. Especially the number and complexity of transition conditions has grown. As a consequence it can be observed that the processing burden of WFMS to evaluate such transition conditions led to performance and responsiveness problems.

Thus there is a need in the state of the art for further improving the processing of transition conditions within a Workflow Management System or a computer system with comparable functionality.

### SUMMARY OF THE INVENTION

The invention is based on the objective to improve the processing of transition conditions within a WFMS for instance in terms of performance improvements, increased responsiveness and efficiency.

The objectives of the invention are solved by the independent claims. Further advantageous arrangements and embodiments of the invention are set forth in the respective subclaims.

The current invention relates to a computerized method and system for improving the processing of transition conditions within a Workflow Management System or a computer system with comparable functionality. It is assumed that the WFMS controls the execution of a process instance being the instance of a process model of a business process. Moreover the process-model comprises a multitude of transition conditions relating to a multitude of process activities respectively, which, if evaluated to TRUE, decide whether any of said corresponding activities is to be launched for execution.

The method comprises a definition step dynamically and adaptively defining an evaluation sequence of said transition conditions.

Moreover the method comprises a launching step, wherein said activities corresponding to said transition conditions are launched for execution in said evaluation sequence, if said corresponding transition conditions evaluate to TRUE.

The current invention is applicable in situations wherein the transition conditions are associated with control connectors as well as in situations wherein the transition conditions are comprised by so-called decision nodes. The first approach consists in assigning transition conditions to the control connector. The second approach is to have special decision nodes that contain definitions (that is, transition conditions) which control connector should be followed. Both types of transition conditions are evaluated when a particular process instance is being carried out. Evaluation of conditions/expression is performed according to the current state of the art in the order defined by the user when the process model is defined.

The present invention proposes a method to improve the processing of transition conditions (either if associated with control connectors or comprised within decision nodes) by defining the sequence, in which the transition conditions will be evaluated, in such a way that the most likely ones are evaluated first. It is suggested that such a new sequence is determined and defined either dynamically or upon an explicit request from a user. The new sequence is determined based on information that the workflow management system collects when carrying out process instances, that is, based on history information which is available from the audit trail of a WFMS.

The suggested approach achieves a significant improvement of the performance and responsiveness of WFMS during the evaluation of transition conditions within process models.

### BRIEF DESCRIPTION OF THE DRAWINGS

FIG. 1 shows an example of a process model represented by a process graph;

FIG. 2 illustrates the implementation of signatures of activities as input and out containers and the movement of data from one activity to another activity via data connectors;

FIG. 3 illustrates the usage of transition conditions associated with control connectors;

FIG. 4 illustrates the usage of decision nodes;

FIG. 5 illustrates some of the steps being carried out when calculating the new evaluation sequences and updating the process models;

FIG. 6 illustrates that reordering of evaluation sequences also works if the WFMS already divides transition conditions into sub-transition conditions; and

FIG. 7 illustrates technical means for specifying with respect to the WFMS itself that the evaluation-sequence of transition-conditions should be defined dynamically and adaptively during runtime of the WFMS.

### DESCRIPTION OF THE PREFERRED EMBODIMENT

In the drawings and specification there has been set forth a preferred embodiment of the invention and, although specific terms are used, the description thus given uses terminology in a generic and descriptive sense only and not for purposes of limitation. It will, however, be evident that various modifications and changes may be made thereto without departing from the broader spirit and scope of the invention as set forth in the appended claims.

The present invention can be realized in hardware, software, or a combination of hardware and software. Any kind of computer system or other apparatus adapted for carrying out the methods described herein is suited. A typical combination of hardware and software could be a general-purpose computer system with a computer program that, when being loaded and executed, controls the computer system such that it carries out the methods described herein. The present invention can also be embedded in a computer program product, which comprises all the features enabling the implementation of the methods described herein, and which, when being loaded in a computer system, is able to carry out these methods.

Computer program means or computer program in the present context mean any expression, in any language, code or notation, of a set of instructions intended to cause a system having an information processing capability to perform a particular function either directly or after either or both of (a) conversion to another language, code or notation, and/or (b) reproduction in a different material form.

The current invention is illustrated based on IBM's “MQSeries Workflow” workflow management system. Of course any other WFMS could be used instead. Furthermore, the current teaching applies also to any other type of system, which offers WFMS functionalities not as a separate WFMS but within some other type of system.

Introduction

The following is a short outline on the basic concepts of a workflow management system based on IBM's “MQSeries Workflow” WFMS.

From an enterprise point of view the management of business processes is becoming increasingly important. Business processes, or process for short, control which piece of work will be performed by whom and which resources are exploited for this work, i.e., a business process describes how an enterprise will achieve its business goals. A WFMS may support both the modeling of business processes and their execution.

Modeling of a business process as a syntactical unit in a way that is directly supported by a software system is extremely desirable. Moreover, the software system can also work as an interpreter, basically getting as input such a model. The model, called a process model or workflow model, can then be instantiated and the individual sequence of work steps depending on the context of the instantiation of the model can be determined. Such a model of a business process can be perceived as a template for a class of similar processes performed within an enterprise; it is a schema describing all possible execution variants of a particular kind of business process. An instance of such a model and its interpretation represents an individual process, i.e. a concrete, context dependent execution of a variant prescribed by the model. A WFMS facilitates the management of business processes. It provides a means to describe models of business processes (build time) and it drives business processes based on an associated model (runtime). The meta model of IBM's WFMS MQSeries Workflow, i.e. the syntactical elements provided for describing business process models, and the meaning and interpretation of these syntactical elements, is described next. It should be noted that the meta model of MQSeries Workflow is just a particular way of representing business processes. Other meta models, such as Petri Nets do exist. It should however also be noted that process graphs are the typical way of representing business processes in all of these approaches.

In MQSeries, business processes are modeled as direct, acyclic, colored, and weighted graphs. The nodes of the graph represent the activities that need to be carried out and the edges of the graph the control connectors that describe the potential sequence in which the activities are to be carried out. Thus a process model is a complete representation of a business process, comprising a process diagram and the settings that define the logic behind the components of the diagram. Important components of an MQSeries Workflow process model are Processes, Activities, Blocks, Control Flows, Connectors, Data Containers, Data Structures, Conditions, Programs, and Staff. Not all of these elements will be described below.

Activities are the fundamental elements of the meta model. An activity represents a business action that is from a certain perspective a semantic entity of its own.

The flow of control, i.e., the control flow through a running process, determines the sequence in which activities are executed. The MQSeries Workflow workflow manager navigates a path through the process that is determined by the evaluation to TRUE of start conditions, exit conditions, and transition conditions.

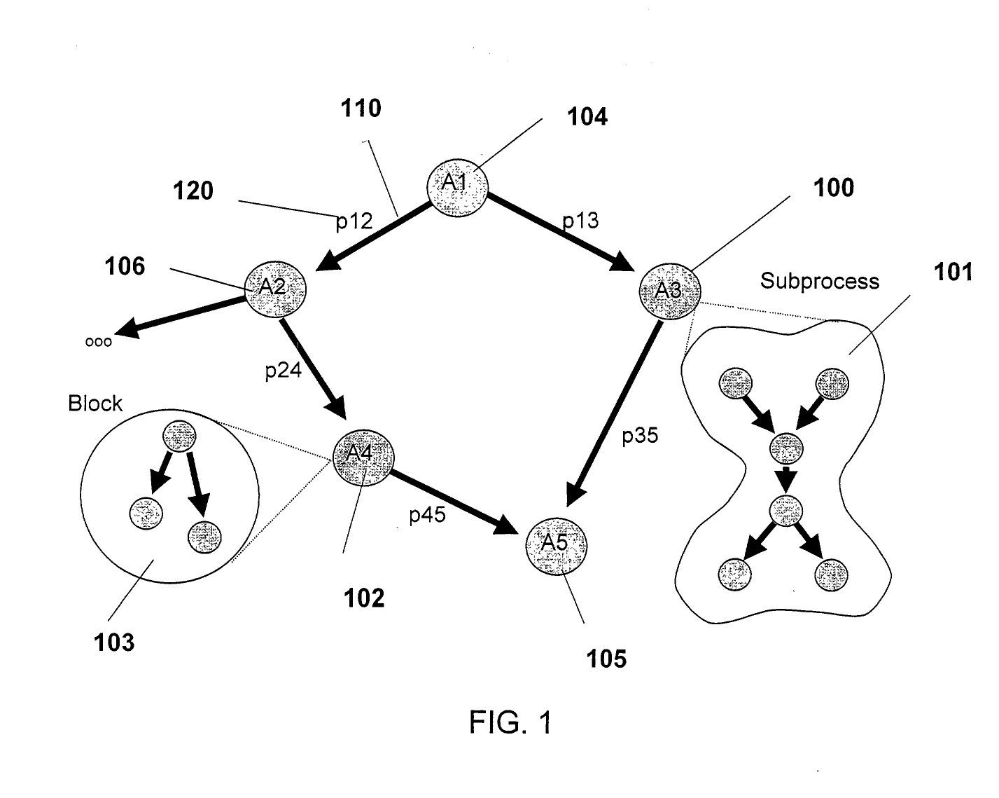

As an example of such a process model, FIG. 1 shows schematically the structure of such a process graph. Activities (A1 up to A5) are represented as named circles; the name typically describes the purpose of the activity. Activities come in various flavors to address the different tasks that may need to be performed. They may have different activity implementations to meet these diverse needs. Program activities are performed by an assigned program, process-activities like for instance 100 are performed by another process 101, and blocks like for instance 102 implement a macro 103 with a built-in do-until loop. Control connectors P12, . . . , P45 are represented as arrows; the head of the arrow describes the direction in which the flow of control is moving through the process. For instance, the control connector 110 defines that activity A1 104 should be followed by activity A2 106. Transition conditions, such as p12 120, determine whether the control connector is actually been followed in a particular process instance. The activity where the control connector starts is called the source activity; where it ends is called the target activity. When more than one control connector leaves an activity, this indicates potentially parallel work. Activities that have no incoming control connectors, such as activity A1 104, are called start activities. Activities that have no outgoing control connector, such as activity A5 105, are called end activities.

Containers and Data Connectors

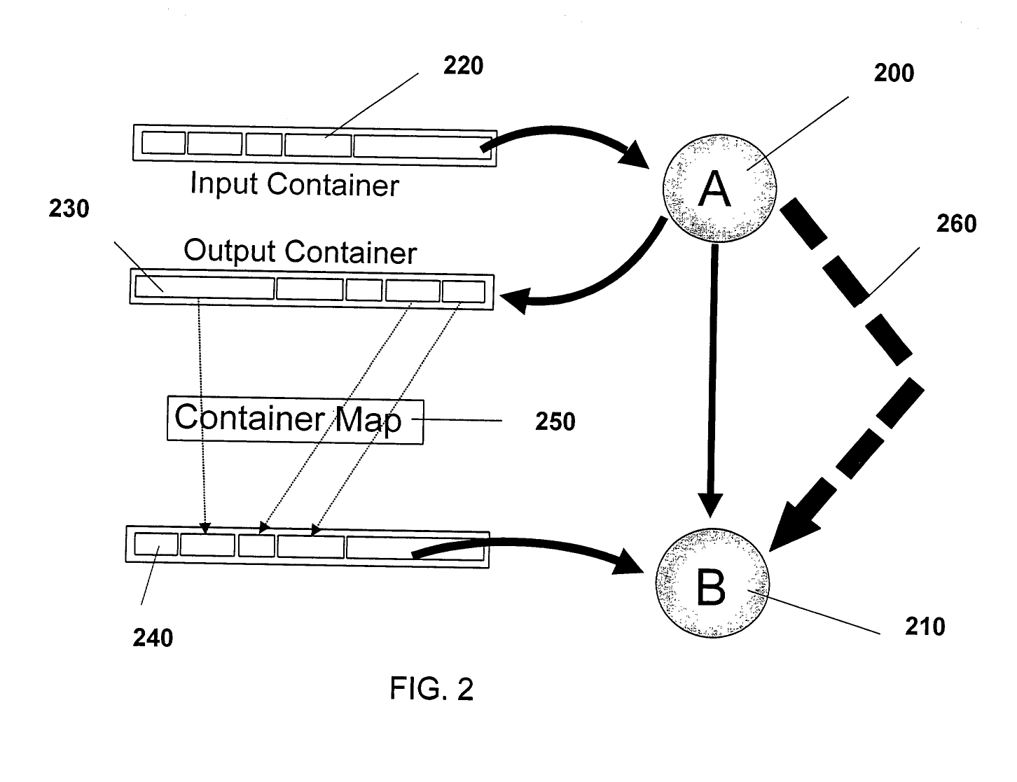

FIG. 2 shows the two activities A 200 and B 210. Both activities A 200 and B 210 have an input container 220, 240 associated with them. Activity A 200 has also an output container 230 associated with it. The input and output container of an activity are conceptually the signature of the activity. The activity obtains data necessary for its execution from the input container and writes data that it produces and that is needed for other activities into the output container. As with signatures, the containers of an activity are only available to the activity. That means they are only available locally. For example, the input container 220 and the output container 230 are only available to the associated activity A 200. Thus, if activity B 210 needs data, for example, from the output container 230 of the activity A 200, this data must be copied from the output container 230 of the activity A 200 to the input container 240 of the activity B 210.

For the purpose of copying data from one of the activities to another activity, a data connector 260 is provided which is depicted in FIG. 2 as a dashed arrow. The data connector 260 of FIG. 2 indicates that the output container 230 of the activity A 200 has to be copied to the input container 240 of the activity B 210.

The output container of an activity and the input container of another activity, however, generally have different data structures, for example contain different data fields. Therefore, a container map 250 is provided in FIG. 2 which defines which data fields of the output container 230 of the activity A 200 are copied into which data fields of the input container 240 of the activity B 210. The container map 250 also specifies if a transformation of the data has to be performed by the workflow management system before the data is copied, e.g., into the input container 240 of the activity B 210.

It should be noted that the process itself typically has also an input container (MQSeries Workflow calls this source) and an output container (MQSeries Workflow calls this sink).

It should be further noted that one or more global containers might be attached to the process or parts of the process. The purpose of a global container is to make data easily available to all activities, possibly without the need to have input and output containers by having the data made available to the activity implementations.

All the data that is passed into the process or made available to the process by the multitude of activity implementations is called the context of the process instance. It is important to note that transition conditions and expressions in decision nodes use the context to determine which control connector should be followed.

Transition Conditions

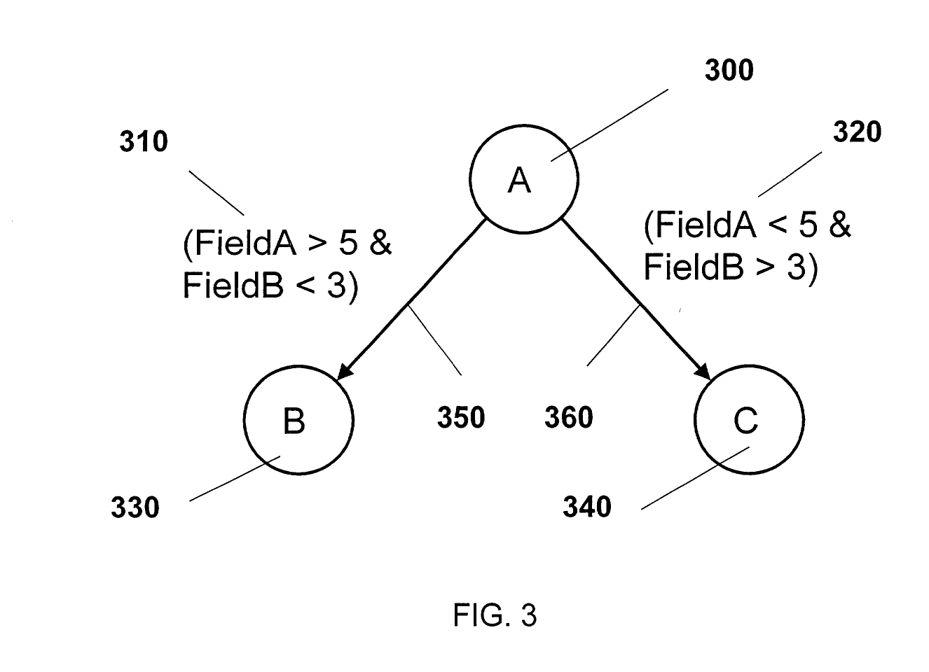

Transition conditions are a means to specify which control connector leaving a certain activity within the underlying process model should be followed when a particular process instance is being carried out. They are expressed as Boolean conditions (predicates of arbitrary complexity) involving fields from the context as well as functions that might access process state information or even information external to the process instance (for example accessing a relational database). When the transition condition of a certain control connector evaluates to TRUE, the appropriate target activity is performed. If the transition condition evaluates to FALSE, the appropriate target activity is skipped and dead path elimination is being carried out. FIG. 3 illustrates the specification of transition conditions. After activity A 300 has been completed, the workflow management system evaluates first the transition condition 310 associated with control connector 350, then the transition condition 320 associated with the control connector 360. If the transition condition 310 evaluates to TRUE, activity B 330 is carried out. If the transition condition 320 evaluates to TRUE, activity C 340 is carried out.

WFMS typically provide the capability to the process modeler to indicate the upper limit of control connectors that actually will be followed when a process instance is being carried out. For example, a process modeler may specify that three control connectors leave an activity, but that only one will be followed. This capability is particularly important if the WFMS cannot evaluate whether the different transition conditions are disjoint or not.

This is an example wherein in addition to the truth values of the transition conditions themselves, the final number of activities to be launched is limited, but further mechanisms. In such cases, situations exist wherein not all transition conditions have to be evaluated (because the maximum number of control connectors have been followed already). These are situations for which the current invention provides further benefits by suggesting an evaluation sequence of the transition conditions. This aspect will become more clear from specifications given below.

Decision Nodes and Other Techniques of Relating Transition-Conditions with Process-Activities

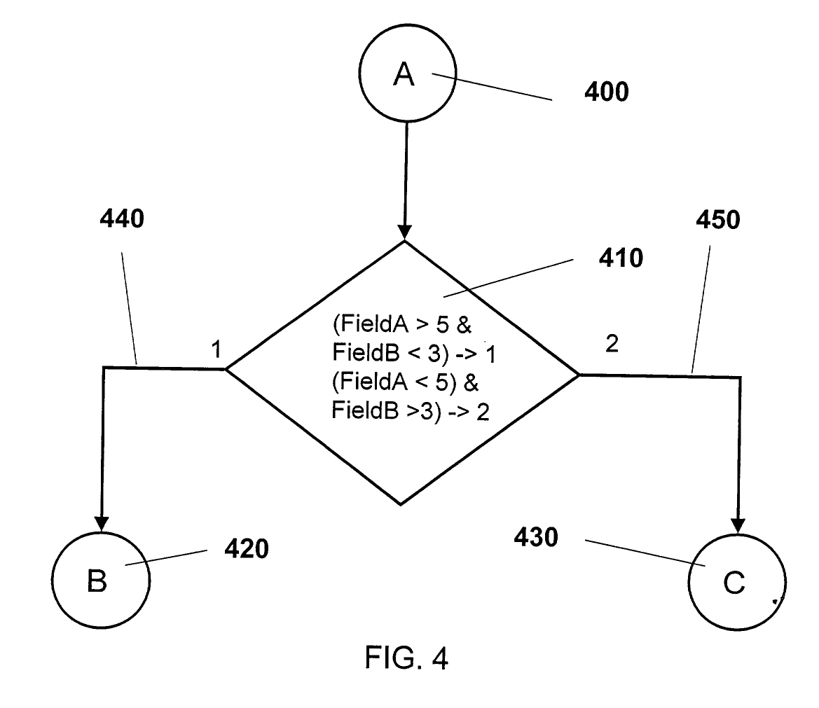

Decision nodes are another means to specify which control connector or set of control connectors should be followed. FIG. 4 illustrates the structure of a decision node. When activity A 400 completes, control flows to the decision node 410. Leaving this decision node are two control connectors. One control connector 440 labeled 1 leads to activity B 420, the other control connector 450 labeled 2 leads to activity C 430. The labels (in the current case “1” and “2”) associated with the control connectors are used in the expression within the decision node. When a particular sub expression of the decision node expression evaluates to TRUE, the control connector with the referenced label is taken. For example, if the sub expression (FieldA>5 & FieldB<3) evaluates to TRUE, the control connector labeled “1” 440 is followed.

Stated in other words a decision node comprises a set of (Boolean) predicates (that is, transition conditions) associated with the individual control connectors leaving said decision node. Depending on the truth value of the transition conditions evaluated at runtime, execution control propagates along the respective control connectors. A description as to the nature and complexity of the predicates has been provided above.

It should be noted that the specifications in FIG. 3 and FIG. 4 lead to the exactly same result. In fact, transition conditions associated with control connectors can always be represented via decision nodes, but the opposite is not necessarily the case. Thus in the following, transition conditions associated with control connectors are being used (if not otherwise indicated) for illustrating the present innovation. Therefore, if the following refers to “transition conditions,” this is to be understood as a generic reference. The notion of transition conditions is meant to simultaneously address the case where transition conditions are associated with control connectors as well as the case where transition conditions are part of a decision node or cases where other technologies of relating transition conditions with process activities to specify the potential sequence of execution are exploited.

Processing of Transition Conditions

The transition conditions are evaluated after the preceeding activity has been completed. The WFMS then evaluates the transition condition relating to each of the control connectors. If a transition condition evaluates to TRUE, the control connector will be followed. If the number of outgoing control connectors reaches the specified or calculated limit of control connectors that may leave the activity, all remaining control connectors are set to FALSE, and processing continues.

Determination of the Evaluation Sequence of Transition Conditions

According to the state of art, the transition conditions are evaluated in the sequence in which the control connectors have been defined when using transition conditions, or in the sequence in which the expressions have been specified in a decision node or in any other type of pre-defined sequence depending on the concrete technology being exploited.

To deduce the current invention in a step by step process, the following five observations can be made.

1. It can be found that with an increasing complexity of process models, the processing burden for evaluating the transition conditions increases significantly, both in terms of the number of transition conditions as well as in terms of computational complexity of each individual transition condition. This is the reason why there exists a significant need to improve the processing of transition conditions within WFMS.

2. As the evaluation of transition conditions is in general a very time-consuming task, it can be recognized that the performance and responsiveness of a WFMS can be improved by dynamically and (self-) adaptively determining the order in which the transition conditions are to be evaluated. This can be done for instance at run-time in parallel to the execution of a process instance. Thus, the current invention suggests to deviate from the state of the art behavior in which a static, predetermined evaluation sequence of transition conditions is known only. This suggestion is based on the consideration that the performance and responsiveness is increased the quicker those transition conditions are evaluated which finally will evaluate to TRUE and thus the quicker the corresponding process-activities can be launched.

3. If the execution history of a certain process model is monitored (for instance, by records written to the WFMS's audit trail thus representing an execution protocol) the relative frequency Pi with which a transition condition i is evaluated to TRUE (or FALSE, respectively) represents a measure for the probability that the transition condition will be evaluated to TRUE (or FALSE, respectively) in the future. It thus can be deduced that evaluating the transition conditions i in a decreasing sequence of the probabilities Pi improves the WFMS's performance.

This teaching can be applied to the example visualized within FIG. 4., According to the state of the art, in the example of FIG. 4, the expression (FieldA>5 & FieldB<3) is always evaluated before the expression (FieldA<5 & FieldB>3) is evaluated (as the evaluation sequence is determined by the sequence the transition conditions are specified within the process model). This static evaluation sequence would be the appropriate one only if in more than 50% of the process instances the control connector 1 is being followed. It is certainly completely inappropriate if, for example, only in 10% of the process instances the control connector 1 is being followed. In particular, since the evaluation of transition conditions is in general a very time-consuming task, a “wrong” evaluation sequence of transition conditions could contribute significantly to performance losses and responsiveness deficiencies.

4. Similar to the observation above the execution history of a certain process model can also be monitored in terms of the (mean) processing time Ti (which can be interpreted as an expected processing time for future evaluations) required to evaluate the transition condition i. In the absence of any further information, the probability that any of the transition conditions i evaluates to TRUE can be assumed to be equal for any transition condition i. It thus can be deduced that evaluating the transition conditions i in a decreasing sequence of the processing times Ti improves the WFMS's performance (execution of the process instance will not be blocked by the evaluation of time-consuming transition conditions).

5. Of course, the last two observations can be combined. According to such an embodiment of the current invention, the WFMS's performance and responsiveness is improved by evaluating the transition conditions i in decreasing sequence of their expected processing times Ti weighted by their corresponding probabilities Pi of being evaluated to TRUE, that is, for instance, in the decreasing sequence of the product Ti*Pi. To fully understand the importance of this observation, it is pointed out that transition conditions might represent arbitrary complex expressions involving the execution of complex and “long” running programs.

Defining the Evaluation Sequence

Once the evaluation sequence of the transition conditions has been dynamically and (self-)adaptively determined, the question arises as to how the most current evaluation sequence can be redefined within the WFMS. Exploiting the fact that certain state of the art WFMS evaluate the transition conditions in the sequence in which the transition conditions occur within the process model, the current invention suggests to rewrite the process model itself with respect to the sequence of the transition conditions in accordance to most current evaluation sequence. This completes the redefinition process of the evaluation sequence.

In general, the above-mentioned problem can be solved by rewriting the evaluation sequence of transition conditions or expressions in decision nodes (or whatever modeling construct the meta model provides for making control flow decisions) within the process model itself. In other words, once a new evaluation sequence of the transition conditions is determined according to one of the above mentioned approaches, it is suggested to define the evaluation sequence by modifying the order of the specifications of the transition conditions within the process model.

In the aforementioned example (10% control connector 1, 90% control connector 2), one would exchange the two expressions so that the transition condition for the control connector 2 is evaluated before the transition condition for the control connector 1.

Rewriting the evaluation sequence can be done outside the WFMS using the following steps:

1. Specifying in the appropriate process model definitions that audit trail records should be written for all control connectors that have been followed.

2. Accumulating the information of the audit trail and determining the probabilities of each control connector to be evaluated as TRUE or FALSE.

3. Performing a mapping from control connector information to the appropriate transition condition.

4. Changing the definition in the process model.

5. Resubmitting the new process model definition to the WFMS.

These steps must be carried out periodically or in general at recurring points in time to ensure that the evaluation sequence is always up-to-date.

The disadvantages of this approach are manifold. They include: (a) that carrying out the outlined steps is a time-consuming task and, since manual activities may be involved, also an error-prone task;(b)that the programs needed in the individual steps are rather complicated; and (c) that the user must guess when it is time to rerun the outlined steps again.

Automated Evaluation Order Rewriting

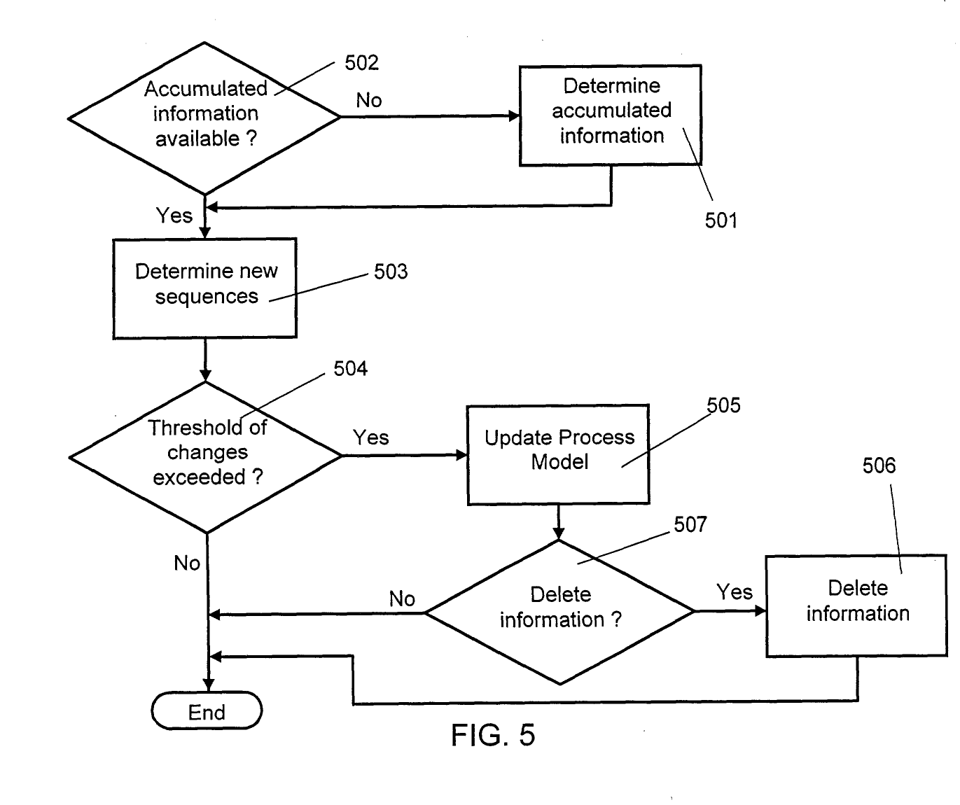

Having the WFMS directly carrying out the necessary steps can solve the outlined disadvantages. This involves conceptually five steps. FIG. 5 visualizes an overview of the process for determining the evaluation sequence and for redefining the sequence by updating the corresponding process model.

Referring to FIG. 5 the following steps can be identified. First, in Step 501, collect the detail information for each control connector and corresponding transition condition that is being touched when a process instance is being carried out, if it is determined in Step 502 that no accumulated information is available as yet.

Second, accumulate the collected detail information into statistical information (Step 501). Third, determine 503 the new evaluation sequences of transition conditions or expressions in decision nodes based on the statistical information created in the second step.

Fourth, if a predefined threshold number of changes is determined to be exceeded in Step 504, the process models can be updated. The process model is then updated (Step 505) with a rewritten evaluation sequence as determined in Step 503. At recurring points, in time the process model has to be updated. These points in time can be determined for instance by determining the number of changes to be applied to the evaluation sequence of the process model to arrive at the newly determined evaluation sequence. Fifth, if it is determined in Step 507 that deletion of the information is desired, clearing the accumulated and detail information (Step 506).

Collection of Detail Information

Collecting the detail information that means the truth values, their relative frequency and the processing times required for evaluating of the transition conditions of the control connectors is a side product of navigating through a process instance. This information can be kept in memory for immediate accumulation, as described in Steps 501-502, written into the process instance, or written to the audit trail.

Accumulation of Detail Information

In this step, the truth values of each processed control connector are accumulated. Accumulation can be done in two different ways. First, the truth-values, their relative frequency and the processing times required for evaluating of the transition conditions of the individual control connectors are immediately calculated. The information can be kept in memory until the WFMS is shut down or after a user-specified interval, when it is written to some persistent store. If the information is written to a persistent store, the newly created information is merged with the information already stored on the persistent store. Second, the truth values of the control connectors are accumulated from the information written upon a request generated either by a user or by the WFMS system itself. This can be an extra request or it might be carried out when the new sequence of evaluation for transition conditions and expressions in decision nodes is requested.

Determine New Evaluation Sequences

The accumulated information is now used to determine the new evaluation sequences. This step is carried out as the result of an appropriate request to recalculate the evaluation sequence of transition conditions or expressions in decision nodes. It assigns to each transition condition a certain probability that the appropriate transition condition evaluates to TRUE such that the associated control connector is being taken.

Update Process Models

If the new probabilities are different from the existing probabilities, then the transition conditions are re-ordered according to the newly calculated probabilities. Optionally one might specify a threshold, which must be exceeded to actually have the transition conditions, re-ordered. This could eliminate the re-ordering if the changes are of a temporary nature only.

Clearing Information

In a last step, the detail information and accumulated information is deleted, if indicated so. Keeping the accumulated information and include it in the accumulation step of a future evaluation sequence processing reduces the probability that temporary changes cause the re-ordering of the evaluation sequences.

Reordering Evaluation Sequence of Sub-Expressions

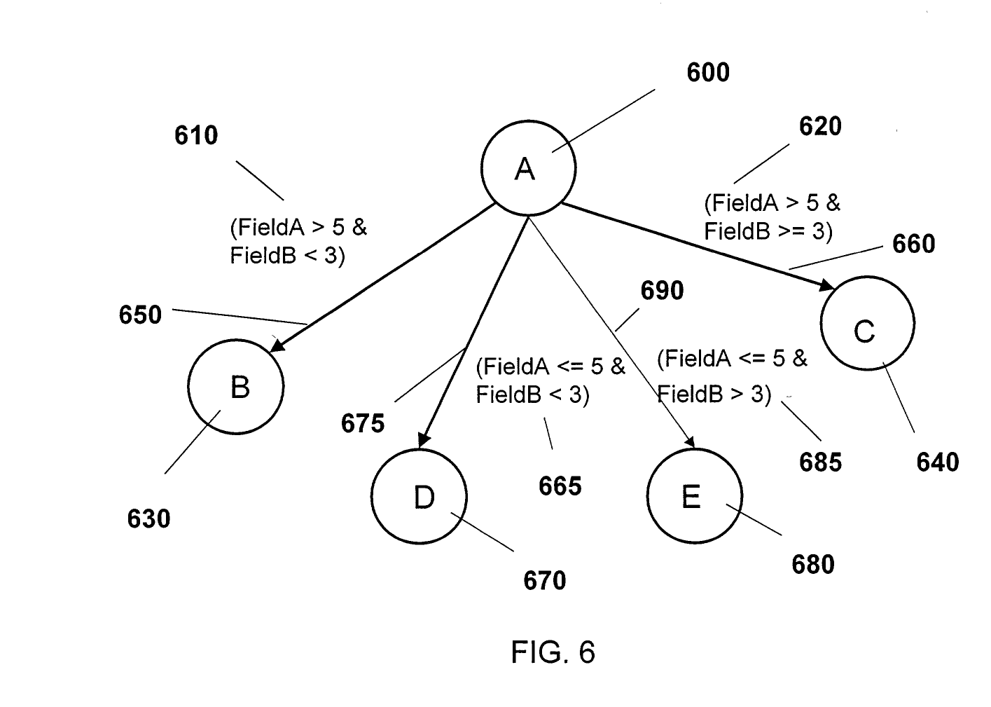

It should be noted that the WFMS could apply the outlined process also if the WFMS performs some internal rearrangement of transition condition processing. FIG. 6 illustrates a situation where the WFMS could rearrange the processing of transition conditions by extracting common sub-expressions from the individual transition conditions. It would extract the sub-expression (FIELDA>5) from the transition conditions 610 and 620 and the sub-expression (FIELDA<=5) from the transition conditions 665 and 685 and then processes those sub-expressions before processing the remaining sub-expressions. When performing reordering of evaluation sequences, the WFMS would use the sub-expressions as the granularity for re-ordering.

Specification of Evaluation Reordering

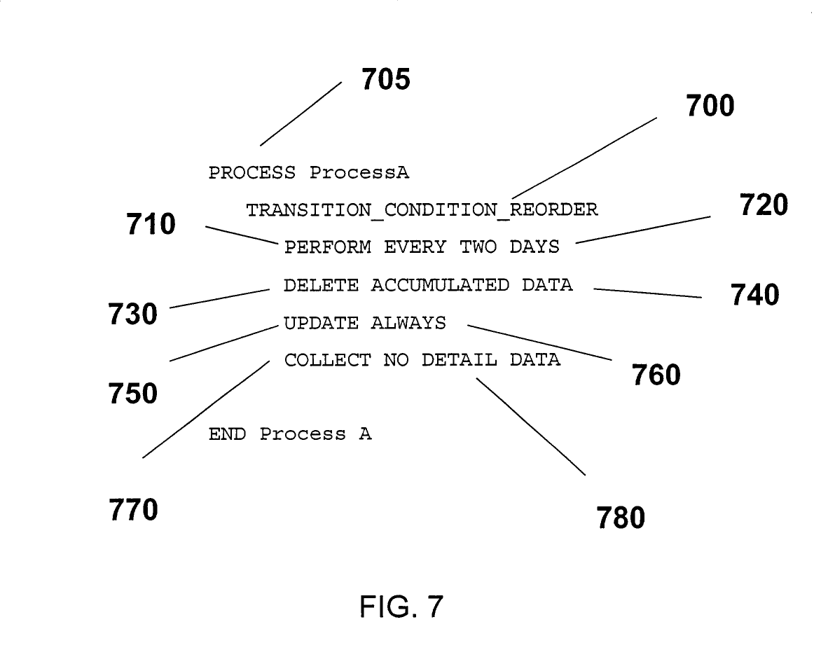

FIG. 7 illustrates technical means how one could specify with respect to the WFMS itself that re-ordering should take place. The specifications are expressed using extensions to the Flow Definition Language of MQSeries Workflow. The keyword PROCESS 705 starts the definition of a process. The new keyword TRANSITION_CONDITION_REORDER 700 starts the definition of the appropriate properties whether and how the WFMS should carry out reordering the evaluation sequences of transition conditions. The PERFORM keyword 710 is used to indicate how the reordering is initiated. EVERY TWO DAYS 720 causes the reordering processing to take place every two days automatically initiated by the WFMS. Other options could be BY USER to indicate that it is performed when initiated by the user via an appropriate request. The keyword DELETE 730 is used to indicate whether the information used to derive the new evaluation sequences should be deleted (or reset to zero). ACCUMULATED DATA 740 indicates that the accumulated data should be deleted. The keyword UPDATE 750 specifies under which conditions the process models should be updated. The parameter ALWAYS 760 indicates that the process models should always be updated. Another option could be THRESHOLD to indicate that a certain threshold must be exceeded to have the process models being updated. The keyword COLLECT 770 is used to indicate which type of data should be collected, for example NO DETAIL DATA 780 indicates no detail information is collected. Further keywords and parameters may be supported to fine-tune the processing of the WFMS.

1. A computerized method for improving processing of transition conditions within a workflow management system (WFMS), said WFMS controlling execution of a process instance, said process instance being an instance of a process model of a business process, and said process model comprising a plurality of transition conditions corresponding to a plurality of respective process activities, and wherein an evaluation of any of said transition conditions to TRUE within said process instance determines whether any of said corresponding process activities is to be launched for execution, said method comprising:
a definition step for dynamically and adaptively defining an evaluation sequence of said transition conditions; and
a launching step for launching said process activities corresponding to said transition conditions for execution in said evaluation sequence if said corresponding transition conditions evaluate to TRUE.

2. A computerized method for improving the processing of transition conditions within a WFMS according to claim 1,
wherein said evaluation sequence is defined such that in the mean of elapsed time for evaluation of transition conditions, which finally evaluate to TRUE is significantly shorter than elapsed time for evaluation of transition conditions which finally evaluate to FALSE.

3. A computerized method for improving the processing of transition conditions within a WFMS according to claim 2,
wherein said definition step further comprises rewriting a sequence of said transition conditions in said process model according to the order of said evaluation sequence.

4. A computerized method for improving the processing of transition conditions within a WFMS according to claim 2,
wherein said definition step further comprises redefining said evaluation sequence only if the number of differences with a newly determined evaluation sequence is larger than a predefined threshold.

5. A computerized method for improving the processing of transition conditions within a WFMS according to claim 2,
wherein said definition step further comprises determining, from the execution history of said process model, probabilities Pi that transition conditions i will be evaluated to TRUE, and defining said evaluation sequence by a decreasing sequence of said probabilities Pi.

6. A computerized method for improving the processing of transition conditions within a WFMS according to claim 2,
wherein said definition step, further comprises
determining, from the execution history of said process model, expectation values for processing times Ti for evaluating transition conditions i,
wherein said evaluation sequence is defined by a decreasing sequence of said processing times Ti.

7. A computerized method for improving the processing of transition conditions within a WFMS according to claim 2,
wherein in said definition step further comprises
determining, from the execution history of said process model, probabilities Pi that transition conditions i will be evaluated to TRUE, and
determining, from the execution history of said process model, expectation values for processing times Ti for evaluating transition conditions i,
wherein said evaluation sequence is defined by a decreasing sequence of said processing times Ti weighted by said probabilities Pi.

8. A computerized method for improving the processing of transition conditions within a WFMS according to claim 1,
wherein said transition conditions are arbitrary complex Boolean predicates optionally comprising execution of further programs, and
wherein said definition step further comprises
decomposing said transition conditions into a set of sub-expressions, and
defining said evaluation sequence with respect to said sub-expressions.

9. A computerized method for improving the processing of transition-conditions within a WFMS according to claim 1, wherein said definition-step is executed during execution of said process instance before evaluating said transition conditions.

10. A computerized method for improving the processing of transition-conditions within a WFMS according to claim 1, wherein said definition step is executed at recurring points in time.

11. A computerized method for improving the processing of transition conditions within a WFMS according to claim 1, wherein said method is executed by said WFMS itself.

12. A system for improving processing of transition conditions within a workflow management system (WFMS), said WFMS controlling execution of a process instance, said process instance being an instance of a process model of a business-process, and said process model comprising a plurality of transition conditions corresponding to a plurality of respective process activities, and wherein an evaluation of any of said transition conditions to TRUE within said process instance determines whether any of said corresponding process activities is to be launched for execution, said system comprising:
means for dynamically and adaptively defining an evaluation sequence of said transition conditions; and
means for launching said process activities corresponding to said transition conditions for execution in said evaluation sequence if said corresponding transition conditions evaluate to TRUE.

13. A computer program product stored on a computer usable medium, comprising computer readable program means improving processing of transition conditions within a workflow management system (WFMS), said WFMS controlling execution of a process instance, said process instance being an instance of a process model of a business-process, and said process model comprising a plurality of transition conditions corresponding to a plurality of respective process activities, and wherein an evaluation of any of said transition conditions to TRUE within said process instance determines whether any of said corresponding process activities is to be launched for execution, said computer program product comprising:
first code means for dynamically and adaptively defining an evaluation sequence of said transition conditions; and
second code means for launching said process activities corresponding to said transition conditions for execution in said evaluation sequence if said corresponding transition conditions evaluate to TRUE.
